(19) United States
(12) Patent Application Publication
(10) Pub. No.: US 2007/0278862 A1
(43) Pub. Date: Dec. 6, 2007

(54) Structure to control a magnetic reed switch

(76) Inventor: Chen-Kai Lin, Magong City (TW)

Correspondence Address: Chen-Kai Lin, P.O. Box No. 6-57, Junghe, Taipei, 235 R.O.C., omitted

(21) Appl. No.: 11/500,316

(22) Filed: Aug. 8, 2006

(30) Foreign Application Priority Data
May 30, 2006 (TW) 095209419

(51) Int. Cl. H02H 3/00; H01H 9/30

(52) U.S. Cl. 307/131; 218/1

(57) ABSTRACT

The present invention provides a structure to control a magnetic reed switch that includes a first electric conductor that extends an appropriate length along a first path and a magnetic reed switch, which includes at least a first reed and a second reed, disposed to one side of the first electric conductor. A magnetic field produced perpendicular to the first path when an electric current flows through the first electric conductor is used to produce a magnetic response in the first reed and the second reed of the magnetic reed switch, thereby causing the first reed and the second reed to make contact, and thus rendering the magnetic reed switch in a conductive state.

### BACKGROUND OF THE INVENTION

(a) Field of the Invention

The present invention relates to a structure to control a magnetic reed switch, and more particularly to a structure that uses an electric current to produce a magnetic field. The magnetic field is then used to control a magnetic reed switch positioned within the magnetic field range.

(b) Description of the Prior Art

Taiwan patent No. 141365, entitled “Burglar Magnetic Reed Switch”, comprises magnets and a magnetic reed switch, wherein the magnets are connected to the magnetic reed switch, and magnetism of the magnets is used to enable two magnetic reeds to mutually conductively connect.

In addition, Taiwan patent No. 499985, entitled “Electronic Meter Structure Using a Magnetic Reed Switch to Respond to Speed”, comprises magnets and a magnetic reed switch, wherein the magnets are connected to the magnetic reed switch, and magnetic strength of the magnets is used to control mutual conductive connection between magnetic reeds of the magnetic reed switches.

However, the aforementioned prior art both use magnetism of the magnets to magnetically attract the magnetic reeds of the magnetic reed switch, thereby controlling mutual attraction and conductive connection between the magnetic reeds. Hence, actuation of the magnetic reed switches is controlled by material magnets.

### SUMMARY OF THE INVENTION

Prior art uses magnetism of magnets to control a magnetic reed switch, whereas the present invention provides a structure that does not use magnets to control a magnetic reed switch.

The present invention further provides a structure to control a circuit matching the magnetic reed switch according to actuation of the aforementioned magnetic reed switch.

A structure to control a magnetic reed switch of the present invention comprises a first electric conductor that extends an appropriate length along a first path and a magnetic reed switch disposed to one side of the first electric conductor. The magnetic reed switch comprises at least a first reed and a second reed. A magnetic field is produced when an electric current passes through the first electric conductor, and the first reed and the second reed of the magnetic reed switch are positioned within the magnetic range of the magnetic field.

The aforementioned first electric conductor is straight.

A curve is formed in a section of the aforementioned first electric conductor, and the magnetic reed switch is positioned to one side of the curved section of the first electric conductor.

Encircling loops are formed in a section of the aforementioned first electric conductor; the encircling loops comprise at least one non-contacting encircling loop, and the magnetic reed switch is positioned within the encircling loops.

A structure to control a magnetic reed switch comprises a first electric conductor that extends an appropriate length along a first path, a second electric conductor that extends an appropriate length along a second path and a magnetic reed switch disposed between the first electric conductor and the second electric conductor. The magnetic reed switch comprises at least a first reed and a second reed. A first magnetic field perpendicular to the first path is produced when an electric current flows through the first electric conductor, and an electric current flowing in the opposite direction to that flowing through the first electric conductor produces a second magnetic field perpendicular to the second path, and the first reed and the second reed of the magnetic reed switch is positioned within the magnetic range of the first magnetic field and the second magnetic field.

An optical signal circuit is connected between the aforementioned first electric conductor and the second electric conductor.

The aforementioned optical signal circuit is rectified by means of a diode, then a capacitor implements filtering of the rectified electric current, and a resistor reduces current pressure drop, thereby causing a light-emitting diode to emit an optical signal.

A sound signal circuit is connected between the aforementioned first electric conductor and the second electric conductor.

The aforementioned sound signal circuit is rectified by means of a diode, then a capacitor implements filtering of the rectified electric current, and a zener diode implements current limiting, thereby enabling the electric current to actuate a transistor which activates a buzzer, and the buzzer then emits a sound signal.

The present invention is provided with the following characteristics:

1. The first electric conductor can be formed with diverse path configurations, and each of the path configurations is able to produce a magnetic field to actuate the magnetic reed switch.

2. The magnetic reed switch can be disposed between the first electric conductor and the second electric conductor, and equidirectional magnetic fields produced by the first electric conductor and the second electric conductor are used to actuate the magnetic reed switch.

3. The present invention uses a magnetic field produced by an electric current to control a magnetic reed switch, and motive force actuating the magnetic reed switch is the magnetic field produced by the electric current.

4. The magnetic field must attain a specific value before it is able to actuate the magnetic reed switch, and uses the principle of “the greater the electric current, the greater the magnetic field” to derive size of the working current at that time by backward inference. Hence, using such a principle, state of the working current can be known according to whether the magnetic reed switch has been actuated or not

5. Because errors may exist in the magnetism actuating the magnetic reed switch due to various manufacturing factors, thus, the present invention adjusts the distance between the magnetic reed switch and the electric conductors prior to disposition, and uses the principle of “the greater the distance, the smaller the magnetic field” to appropriately counteract the aforementioned errors in actuating magnetism.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a schematic view according to the present invention.

FIG. 2 shows a schematic view of a first embodiment according to the present invention, wherein a first reed and a second reed of a magnetic reed switch are in mutual contact.

FIG. 3 shows a schematic view of the first embodiment according to the present invention, wherein the first reed and the second reed of the magnetic reed switch are separated.

FIG. 4 shows a schematic view of a second embodiment according to the present invention, wherein the first reed and the second reed are partially surrounded by a first electric conductor.

FIG. 5 shows a schematic view of a third embodiment according to the present invention, wherein the first reed and the second reed are encircled by at least one non-contacting loop of the first electric conductor.

FIG. 6 shows a schematic view of a fourth embodiment according to the present invention, wherein the first reed and the second reed are positioned between the first electric conductor and a second electric conductor, and direction of the electric current passing through the first electric conductor is opposite to that passing through the second electric conductor.

FIG. 7 shows a schematic view of the present invention including an optical signal circuit in use in a power supply circuit.

FIG. 8 shows a schematic view of the present invention including a sound signal circuit in use in a power supply circuit.

### DETAILED DESCRIPTION OF THE PREFERRED EMBODIMENTS

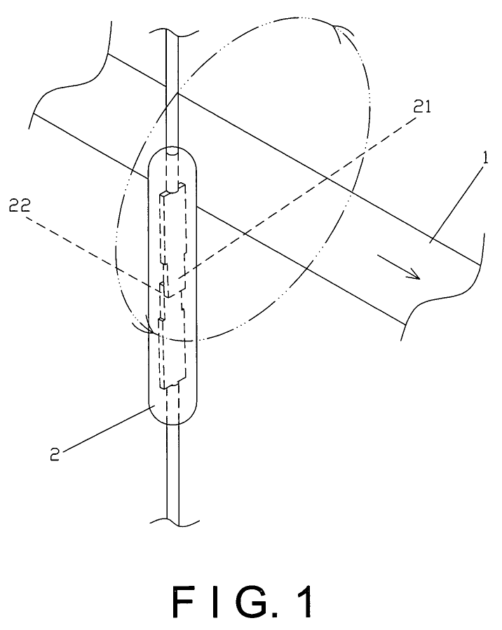

Referring to FIG. 1, which shows the present invention comprising a first electric conductor (1) and a magnetic reed switch (2), wherein the first electric conductor (1) is extended to an appropriate length along a first path. The first electric conductor (1) essentially can be a conductive metallic strip or metallic wire, and the magnetic reed switch (2) is positioned to one side of the electric conductor (1). The magnetic reed switch comprises a first reed (21) and a second reed (22), and end positions of the first reed (21) and the second reed (22) mutually overlap.

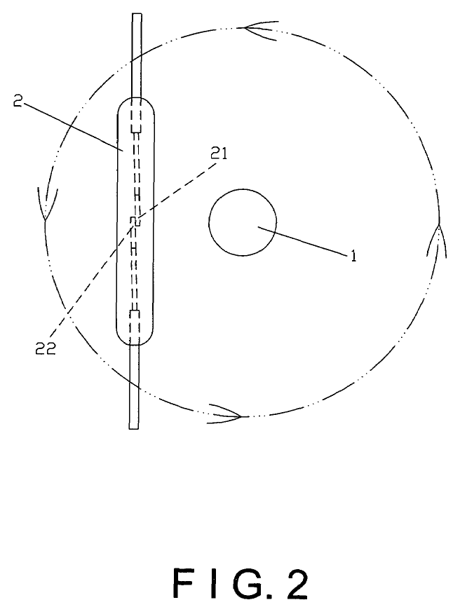

Referring to FIGS. 1 and 2, wherein the straight arrowhead in FIG. 1 represents the direction of an electric current. A magnetic field is produced (the circular loop in FIG. 2) when the electric current passes through the first electric conductor (1), and directions of the magnetic field and the electric current are mutually perpendicular. Because the magnetic reed switch (2) is positioned to one side of the first electric conductor (1) and within the effective range of the aforementioned magnetic field, thus, when strength of the magnetic field affecting the magnetic reed switch (2) is sufficiently large, opposite magnetic polarities are induced in the overlapping areas of the first reed (21) and the second reed (22), thereby causing the first reed (21) and the second reed (22) to mutually attract and form a connection point, thus rendering the magnetic reed switch (2) in a conductive state.

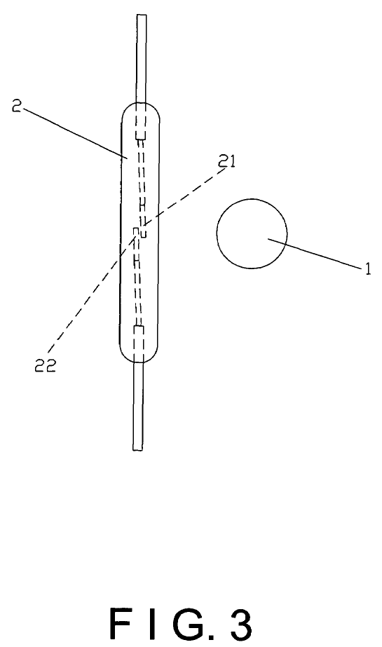

Referring to FIG. 3, as soon as the strength of the magnetic field affecting the magnetic reed switch (2) dies out or weakens, then magnetism of the overlapping areas of the first reed (21) and the second reed (22) also dies out or weakens, whereupon the overlapping areas of the first reed (21) and the second reed (22) are no longer in contact, thus rendering the magnetic reed switch (2) in a non-conductive state.

When operating the present invention, an “oversized working current” produces a magnetic field of sufficient strength to effect the aforementioned actuation of the magnetic reed switch (2). Hence, actuation of the magnetic reed switch (2) can be used to produce a signal responding to the “oversized working current”.

A “from zero to non-zero working current” is also able to produce a magnetic field of sufficient strength to effect the aforementioned actuation of the magnetic reed switch (2). Hence, actuation of the magnetic reed switch (2) can be used to produce a signal responding to the “a working current exists”.

When “working current reaches a certain value”, this is also able to produce a magnetic field of sufficient strength to effect the aforementioned actuation of the magnetic reed switch (2). Hence, actuation of the magnetic reed switch (2) can be used to produce a signal responding to the “the working current has reached a certain value”.

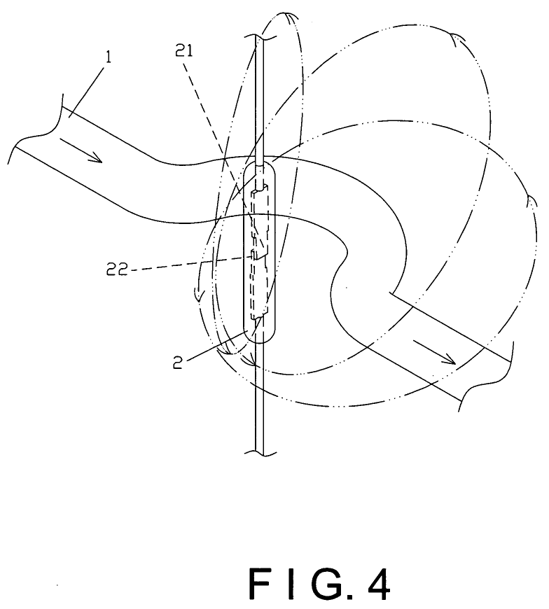

Referring to FIG. 4, which shows an electric current passing through the first electric conductor (1), a section of which partially surrounds the locality of the first reed (21) and the second reed (22) of the magnetic reed switch (2), that is, the magnetic reed switch (2) is positioned in the vicinity of the center of curvature of a curved section of the first electric conductor (1), whereby the magnetic fields produced by the electric current passing through the curved section of the first electric conductor (1) collectively effect the first reed (21) and the second reed (22).

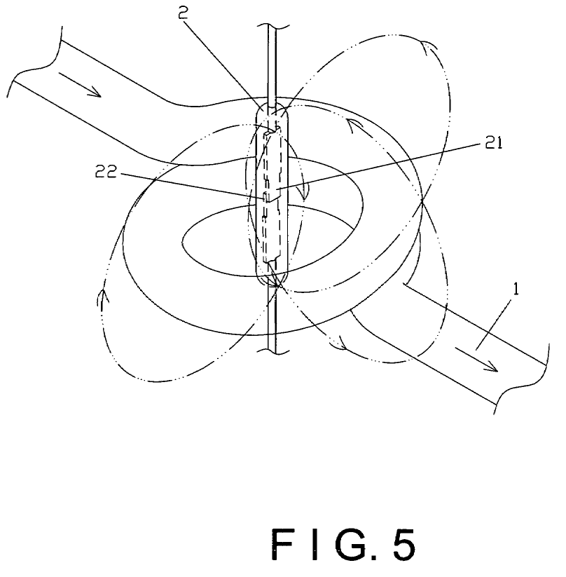

Referring to FIG. 5, which shows an electric current passing through the first electric conductor (1), an encircling section of which encircles the locality of the first reed (21) and the second reed (22) of the magnetic reed switch (2), wherein the encircling section of the first electric conductor (1) forms non-contacting encircling loops. The encircling section includes at least one non-contacting encircling loop. That is, the magnetic reed switch (2) is positioned within the non-contacting encircling loops of the first electric conductor (1), whereby the magnetic fields produced by an electric current passing through the non-contacting loops of the first electric conductor (1) collectively effect the magnetic reed switch (2), moreover, the more the number of encircling loops there are in the first electric conductor (1), the greater the magnetic field produced.

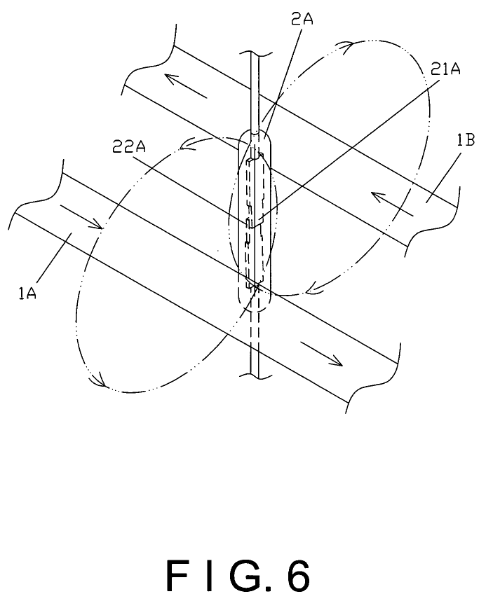

Referring to FIG. 6, which shows another embodiment of the present invention, comprising a first electric conductor (1A), a second electric conductor (1B) and a magnetic reed switch (2A), wherein the first electric conductor (1A) is extended to an appropriate length along a first path, and the second electric conductor (1B) is extended to an appropriate length along a second path. The magnetic reed switch (2A) comprises a first reed (21A) and a second reed (22A), and is disposed between the first electric conductor (1A) and the second electric conductor.

An electric current passing through the first electric conductor (1A) produces a first magnetic field perpendicular to the first path, and an electric current passing through the second electric conductor (1B) in an opposite direction to that of the first electric conductor (1A) produces a second magnetic field perpendicular to the second path. Because the first reed (21A) and the second reed (22A) of the magnetic reed switch (2A) are positioned within the magnetic range of the first magnetic field and second magnetic field, and direction of the magnetic fields of the first magnetic field and second magnetic field are identical, thus, the first magnetic field and second magnetic field collectively effect the first reed (21A) and the second reed (22A). The aforementioned first electric conductor (1A) can be a live wire in a power supply circuit, and the second electric conductor (1B) can be a neutral wire in a power supply circuit.

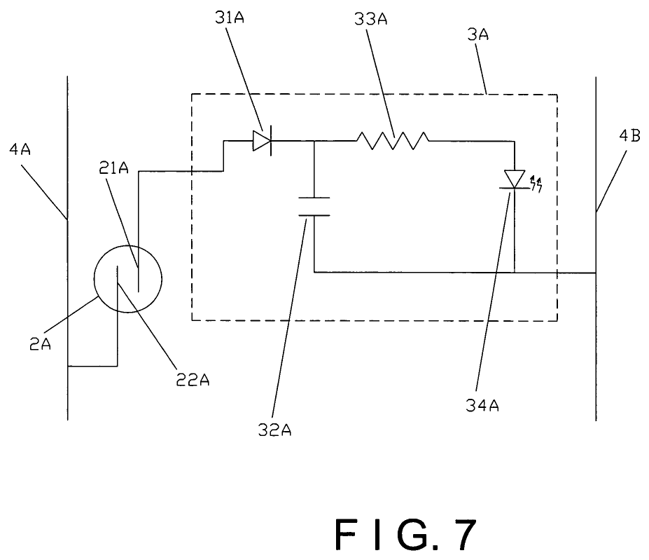

Referring to FIG. 7, which shows an optical signal circuit (3A) comprising a diode (31A), a capacitor (32A), an electrical resistor (33A) and a light-emitting diode (34A), and an electric current is passed through the optical signal circuit (3A). One end of the optical signal circuit (3A) is connected to the first reed (21A) of the magnetic reed switch (2A), and the second reed (22A) of the magnetic reed switch (2A) is connected to a live wire (4A) of a power supply circuit, and another end of the optical signal circuit (3A) is connected to a neutral wire (4B) of the power supply circuit. Current direction in the live wire (4A) of the power supply circuit is opposite to that in the neutral wire (4B) of the power supply circuit. A magnetic field is produced when the electric current passes through the live wire (4A), which causes the first reed (21A) and the second reed (22A) of the magnetic reed switch (2A) to respond to the magnetism and make contact, at which time, the electric current passes through the diode (31A) and is rectified to enable a stable input current, whereupon the capacitor (32A) implements filtering of the rectified electric current to decrease current noise in the electric current, and the electrical resistor (33A) reduces current pressure drop, thus causing the light-emitting diode (34A) to emit an optical signal, thereby indicating that an electric current has passed through the aforementioned power supply circuit or current load of the power supply circuit has already reached a certain value. If the electric current passing through the aforementioned live wire (4A) is reduced, then strength of the magnetic field produced is insufficient to cause the first reed (21A) and the second reed (22A) to respond to the magnetism and make contact, thus the optical signal circuit (3A) stops functioning, and no optical signal is displayed, or the electric current stops flowing through the live wire (4A), then the first reed (21A) and the second reed (22A) will no longer make contact due to the magnetic field dieing out, thus, the optical signal circuit (3A) also stops functioning, and no optical signal is displayed.

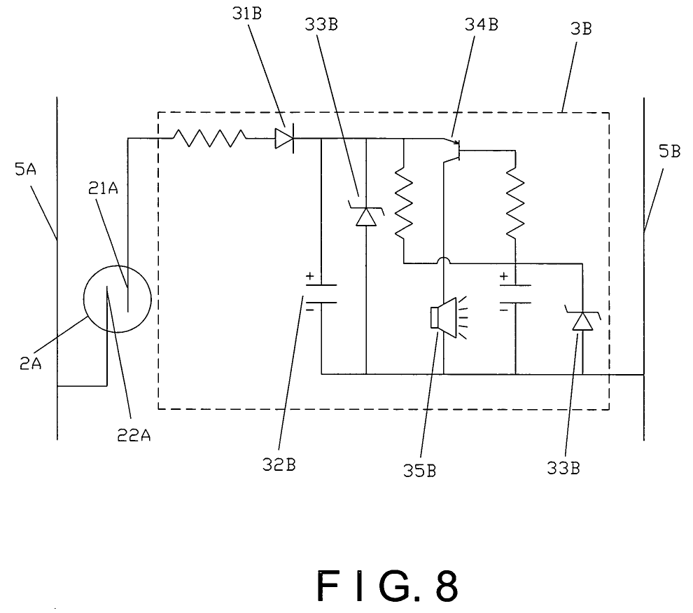

Referring to FIG. 8, which shows a sound signal circuit (3B) comprises a diode (31B), a capacitor (32B), a zener diode (33B), a transistor (34B) and a buzzer (35B), and an electric current is passed through the sound signal circuit (3B). One end of the sound signal circuit (3B) is connected to the first reed (21A) of the magnetic reed switch (2A), and the second reed (22A) of the magnetic reed switch (2A) is connected to a live wire (5A) of a power supply circuit, and another end of the sound signal circuit (3A) is connected to a neutral wire (5B) of the power supply circuit. Current direction in the live wire (5A) of the power supply circuit is opposite to that in the neutral wire (5B) of the power supply circuit. A magnetic field is produced when the electric current passes through live wire (5A), which causes the first reed (21A) and the second reed (22A) of the magnetic reed switch (2A) to respond to the magnetism and make contact, at which time the electric current is rectified through the diode (31B) to enable a stable input current, whereupon the capacitor (32B) implements filtering of the rectified current to decrease current noise in the electric current, and the zener diode (33B) implements current limiting on the electric current. When the electric current is greater than the voltage of the transistor (34B), then the transistor (34B) is placed in an active state, at which time the buzzer (35B) is actuated by the transistor (34B) and emits a sound signal, thereby revealing that the electric current has passed through the aforementioned power supply circuit or current load of the power supply circuit has already reached a certain value. If the electric current passing through the aforementioned live wire (5A) is reduced, then strength of the magnetic field produced is insufficient to cause the first reed (21A) and the second reed (22A) to respond to the magnetism and make contact, thereby causing the sound signal circuit (3B) to stop functioning, and no sound is emitted, or the electric current stops flowing through the live wire (5A), then, the first reed (21A) and the second reed (22A) are no longer able to make contact due to the magnetic field dieing out, thereby causing the sound signal circuit to stop functioning, and no sound signal is emitted.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A structure to control a magnetic reed switch, comprising:
a first electric conductor that extends an appropriate length along a first path;
a magnetic reed switch disposed to one side of the first electric conductor, and which comprises at least a first reed and a second reed;
whereby a magnetic field perpendicular to the first path is produced when an electric current passes through the first electric conductor, and the first reed and the second reed of the magnetic reed switch are positioned within the magnetic range of the magnetic field.

2. The structure to control a magnetic reed switch according to claim 1, wherein the first electrical conductor assumes a straight line.

3. The structure to control a magnetic reed switch according to claim 1, wherein a curve is formed in a section of the first electrical conductor, and the magnetic reed switch is positioned in an area surrounded by the curve.

4. The structure to control a magnetic reed switch according to claim 1, wherein encircling loops are formed in a section of the first electrical conductor, the encircling loops comprise at least one non-contacting encircling loop, and the magnetic reed switch is positioned within the encircling loops.

5. A structure to control a magnetic reed switch, comprising:
a first electric conductor that extends an appropriate length along a first path;
a second electric conductor that extends an appropriate length along a second path;
a magnetic reed switch disposed between the first electric conductor and the second electric conductor, and which comprises at least a first reed and a second reed;
whereby a first magnetic field perpendicular to the first path is produced when an electric current flows through the first electric conductor, and an electric current flowing in the opposite direction to that flowing through the first electric conductor produces a second magnetic field perpendicular to the second path, and the first reed and the second reed of the magnetic reed switch is positioned within the magnetic range of the first magnetic field and the second magnetic field.

6. The structure to control a magnetic reed switch according to claim 5, wherein an optical signal circuit is connected between the first electric conductor and the second electric conductor.

7. The structure to control a magnetic reed switch according to claim 6, wherein the optical signal circuit comprises a rectifying diode, a filtering capacitor, a resistor for reducing current pressure drop and a light-emitting diode to provide evidence for passing of a current.

8. The structure to control a magnetic reed switch according to claim 5, wherein a sound signal circuit is connected between the first electric conductor and the second electric conductor.

9. The structure to control a magnetic reed switch according to claim 8, wherein the sound signal circuit comprises at least a rectifying diode, a filtering capacitor, a current limiting zener diode, a transistor and a buzzer actuated by the transistor.
